(19) United States
(12) Patent Application Publication
(10) Pub. No.: US 2016/0116981 A1
(43) Pub. Date: Apr. 28, 2016

(54) ENHANCED FUNCTION INTERACTION DEVICE

(71) Applicant: Siavash Mortazavi, Worcester, MA (US)

(72) Inventor: Siavash Mortazavi, Worcester, MA (US)

(21) Appl. No.: 14/525,487

(22) Filed: Oct. 28, 2014

(51) Int. Cl. G06F 3/01; G06F 3/02; G06F 3/0338

(52) U.S. Cl. CPC G06F 3/014; G06F 3/016; G06F 3/0338; G06F 3/0202

(57) ABSTRACT

A finger-worn interaction device provides a faster, more responsive input and output streams to and from a computing or gaming device and is particularly well suited for high speed, interactive applications. The finger-worn nature relieves the user of a hand-held device that must be continually grasped or held, occupying at least one hand, and instead allows full movement of all digits on both hands to be employed for input activation. A variety of input formats are employed, and disposed as input modules or output modules on a substantially circular frame, such as a finger operated stick, trigger, action button, and roller/trackball operations. Multiple input modules and/or output modules may be disposed on each circular frame, providing a multitude of available inputs that may each be actuated by digits on the user's hand for allowing faster input sequences as users gain proficiency with actuating the multiple input modules.

### BACKGROUND

Computing devices generally require some form of input/output device for receiving input from a user and projecting output to a user. Conventional keyboards, popular for decades, have become supplemented by a pointing device, more commonly denoted a “mouse,” which has further evolved into touchpads and keyboard “knob” implementations. The emergence of smaller devices, with increasing computing power, however, has forced vendors to develop input mechanisms that do not require the space of a full keyboard. Dual duty numeric keypads (allowing text entry from a traditional “touch telephone” style keypad), predictive input analysis, and smaller screen based and physical keypad layouts followed. Smaller input devices, however, tend to increase the user dexterity required for efficient use, and may not be suitable for high speed and precision input, such as that associated with action, adventure, role-playing gaming experiences, and other situations in which, a precise and convenient input method is preferred.

### SUMMARY

A finger-worn input device provides a faster, more responsive input stream to a computing or gaming device and is particularly well suited for high speed, interactive applications. The finger-worn nature relieves the user of a hand-held device that must be continually grasped or held, occupying at least one hand, and instead allows full movement of all digits on both hands to be employed for input activation. A variety of input formats are employed, and disposed as interaction modules on a circular frame, such as a finger operated stick, trigger, action buttons, directional buttons or directional pad, LCD, vibration/rumble element, and roller/trackball operations. Multiple interaction modules may be disposed as input modules on each circular frame, providing a multitude of available inputs that may each be actuated by digits on the user's hand for allowing faster input sequences as users gain proficiency with actuating the multiple interaction modules. The interaction modules also include output modules, which convey output signals such as vibration, light, or video/text rendering.

Configurations herein are based, in part, on the observation that conventional approaches to computer input require a large keyboard (as in the case of a desktop PC), employ small, finely arranged elements (as in reduced keypads/keyboards and touch screens) or employ a handheld controller with actuation and interaction members such as buttons, triggers and finger operated sticks, as in a gaming environment. Unfortunately, therefore, lack of a precise portable and compact interaction device for mobile computing, has led to reliance on interaction mechanisms such as touching and tilting as main interaction methods, by using touch screen, accelerometers, gyroscope, etc. Configurations herein promote portability and convenience in a finger worn device, in view of conventional approaches having no suitable controller available for mobile devices, because available game controllers are so big and not very portable, and other competitor portable devices are limited in functionality or are not very convenient for long-term usage.

Alternate approaches may employ a native keyboard and/or mouse of the host computer, for adapting to environments where controllers are not available. However, the mouse and keyboard are not well suited to the precise and rapid nature of dedicated gaming controllers.

Accordingly, configurations herein substantially overcome the above-described shortcomings by providing a finger-worn controller that disposed on a finger of the user, typically the index finger, and allows simultaneous actuation by multiple fingers. The finger worn device takes the form of a circular or substantially circular frame, appearing as an oversize ring, that slides concentrically around a digit of the user. Multiple interaction modules, such as trigger buttons, finger operated sticks, and rollers define actuation members for receiving input from the user and sending feedback/information to the user. Further, controllers may be worn on both the right and left hands to provide a multitude of input operations and controls to be performed, as conventional gaming controllers typically employ a variety of actuation members on the handheld base.

Alternate configurations of the invention include a multiprogramming or multiprocessing computerized device such as a multiprocessor, controller or dedicated computing device or the like configured with software and/or circuitry (e.g., a processor as summarized above) to process any or all of the method operations disclosed herein as embodiments of the invention. Still other embodiments of the invention include software programs such as a Java Virtual Machine and/or an operating system that can operate alone or in conjunction with each other with a multiprocessing computerized device to perform the method embodiment steps and operations summarized above and disclosed in detail below. One such embodiment comprises a computer program product that has a non-transitory computer-readable storage medium including computer program logic encoded as instructions thereon that, when performed in a multiprocessing computerized device having a coupling of a memory and a processor, programs the processor to perform the operations disclosed herein as embodiments of the invention to carry out data access requests. Such arrangements of the invention are typically provided as software, code and/or other data (e.g., data structures) arranged or encoded on a computer readable medium such as an optical medium (e.g., CD-ROM), floppy or hard disk or other medium such as firmware or microcode in one or more ROM, RAM or PROM chips, field programmable gate arrays (FPGAs) or as an Application Specific Integrated Circuit (ASIC). The software or firmware or other such configurations can be installed onto the computerized device (e.g., during operating system execution or during environment installation) to cause the computerized device to perform the techniques explained herein as embodiments of the invention.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a computer gaming environment suitable for use with configurations disclosed herein;

FIG. 2 shows the finger-worn controller disposed on a user digit (finger);

FIG. 3 shows a configuration of a right hand controller; and

FIG. 4 shows a configuration of a left handed controller.

### DETAILED DESCRIPTION

Conventional desktop computers commonly employ two well-known input devices: a mouse and keyboard. The combination of these two devices is often sufficient enough that most users of computer do not require additional specialized device to do their daily tasks, and this combination has worked for some time in desktop and office environments. The emergence of smaller, more portable devices such as smartphones and tablets replaced the conventional mouse was with touch gestures and the physical keyboard was replaced with on-screen virtual keyboards. Handheld devices also take advantage of different sensors such as accelerometers, to utilize tilt gesture as input. The computer input devices that are used as pointing devices or for manipulating virtual objects may be generally classified in three categories of isotonic, isometric or elastic according to the mobility and the degree of resistance exerted on an actuator, or end-effector, defined by the member that is physically manipulated or contacted by the user.

In an isotonic device, the end-effector moves freely and may be displaced with no resistance or with constant and very low resistance.

In an isometric device (also called a force or pressure device), the end-effector is not mobile or is practically not mobile, and the force applied on the end-effector and transmitted by the latter is measured physically.

In an elastic device, the end-effector is mobile but the resistance on the end-effector increases with the displacement. Isotonic devices, such as a mouse, do not allow continuous input; in contrast, keyboard keys have elastic resistance underneath, and have the capability of giving continuous input, as long as they are pressed.

Omission of a mouse and keyboard on handheld devices has caused the emergence of games that are handheld friendly, but may not support a variety of inputs demanded by a complex and fast moving interactive game. It would be beneficial to develop and implement a user input device to support a gaming experience that demands a complex and continuous combination of inputs.

Conventional approaches to gaming environments requiring high speed complex input sequences include on-screen virtual inputs to control the game. Such approaches employ on-screen sensing and optional textured overlays to define input facilities directly on the rendering screen. There are several drawbacks to such approaches. Screen based facilities occupy space on the screen, potentially obscuring the playing area. When the player moves fingers on the screen, the view of the game is blocked even more.

Virtual buttons do not have tangible marks (or “feel marks”), so player may lose their positions easily, and has to check frequently to see if the fingers are placed on top of buttons correctly. This distracts the player from the game.

Even if there are overlays or textures provided, screen based input provides no haptic feedback when virtual buttons are pressed. When a person pushes a physical button or lever, the tactile/haptic feeling acts as feedback for brain that an action has happened, but when a user performs selection on an unfeatured, flat surface, the only available feedbacks would be soft feedbacks, like visuals and sound effects, from the computer device. Further, depending on the type of the screen, screen protection usage, cleanliness of screen, cleanliness of fingers, having sweat on finger tips, etc. sliding fingers across the screen may become more difficult and less accurate.

Further, there is no well-established working standard of on-screen button formats across different games. For standard input devices, such as keyboard or game controllers on Xbox and PlayStation, as the number and location of buttons are fixed, muscle memory becomes familiar with them and uses them more effectively over time. But different handheld games have various on-screen inputs, with different sizes and locations, and this makes it harder for players to feel comfortable with the input mechanism.

Vendors of interface have created finger stick overlays or protrusion as a medium between your fingers and the virtual buttons/controllers on the screen. Unfortunately this medium works only with games that have perfectly matched buttons on the screen, and has not shown to be a highly ranked product in the market. Such an approach does not guarantee that the player will be able these buttons in a particular game, and also requires porting the overlay with the device. Further, while using these media, the user is again required to cover the screen, obscuring rendered details.

Other approaches wrap handheld devices (usually smartphones) and add extra buttons and controls around the screen. They attempt to bring the look and feel of portable game consoles. However, as such controllers are at least as big as the smartphones they accompany, carrying them around with the smartphone is not very convenient. Another shortcoming is that they just fit one particular device, and they are physically bound to that device only.

‘Other vendors promote a small (pocket sized) Bluetooth® controller for mobile gaming. The size of this device is small enough to be carried around easily, but at the same time, it becomes inconvenient for long-term playing.

Conventional devices directed to finger-based deployment are generally specific to particular uses and not well suited to gaming or fast action response.

Configurations herein include dual (left and right) finger-worn controller devices (controllers) in various embodiments, and related systems, interfaces, and methods of use. One device is designed to be worn on index finger of right hand, and the other on index finger of left hand. They can operate separately, or in conjunction, to serve as an input/output mechanism for various types of computers, including desktop computers, tablets, smart phones, TVs, digital cameras, projectors, etc. Each of these two controllers are equipped with different buttons and interaction modules. Each interaction module may be an input module or an output module. An input module receives user input, typically by manual actuation of a lever or switch, and output modules convey a signal to the user, such as vibration, lights, or a LED/LCD screen or display.

Features include a wireless medium to send/receive data to the connected computer/device, rechargeable batteries, for enabling wireless usage, various buttons/knobs/switches defining input modules responsive to thumbs and middle fingers, power level indicators, and vibration hardware to give tactile feedback to the user.

A data/power port allows hardwired connection to computers and gaming devices, and also serves to charge the batteries through USB ports on computer machines or power adapters.

In a particular configuration, the right finger-worn controller device will be used mainly for action/manipulation mechanisms and the left finger-worn controller device, will be used mainly for navigation/browse interactions. Although the whole interaction experience can happen by using both of these devices simultaneously, it is also possible to use each of them separately for certain applications or devices. For example, the right-hand device is a very good replacement for digital camera remote controllers, a wireless presenter, a controller operated by a patient who cannot move his or her arms easily, a controller operated by surgeons in the operation room, or a driver's companion to answer phone, operate music player, etc. The discussion below illustrates example, features and modules of each controller in a particular configuration. Various alternate arrangements of input modules, controllers and finger placement may be performed.

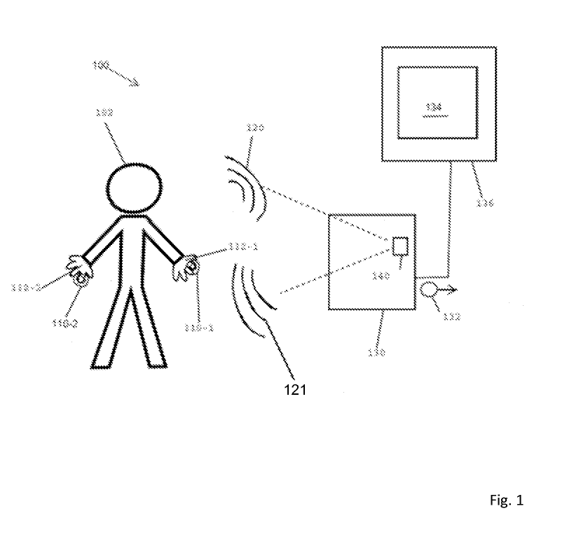

FIG. 1 is a context diagram of a computer gaming environment 100 suitable for use with configurations disclosed herein. Referring to FIG. 1, in a typical gaming environment 100, the finger worn controllers 110-1, 110-2 (110 generally) are employed as a user interaction controller having dedicated right and left controllers disposed on the index finger of the respective hands (112-1 . . . 112-2) of the user 102. The controller 110 transmits input signals 120 to a mobile or stationary computing device 130 such as a phone, tablet, laptop, game console, PC or other suitable processor controlled device. The computing device 130 executes one or more applications 140 responsive to the input signals 120. The computing device 130 renders output 132 in the form of video images 134 on a display 136, which may be separate from the computing device 130 or integrated as a single assembly. The application 140 transmits output signal 121 to the controllers 110, based on its internal logic. The wireless medium on the controllers 110 receive the output signal and activates vibrator elements in the interaction modules 150. Users hands 112 sense the vibration, hence user 102 feels the feedback for the performed action through the controllers 110.

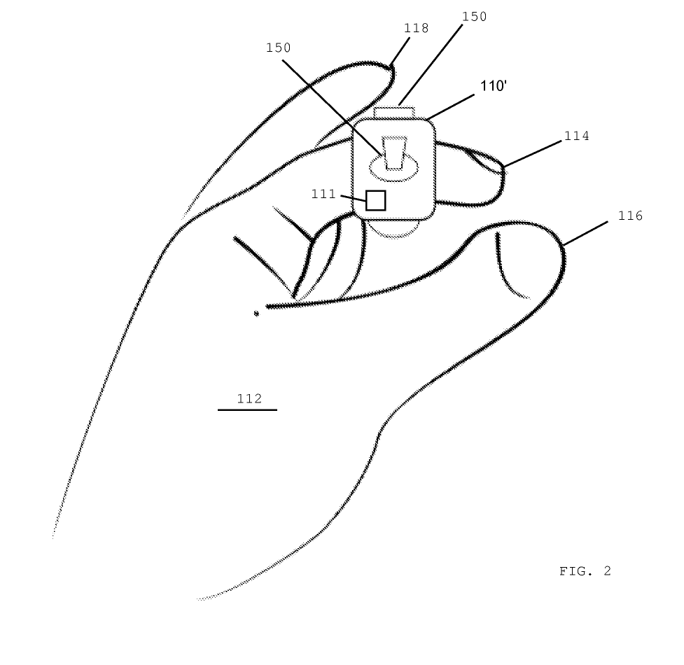

FIG. 2 shows the finger-worn controller disposed on a user digit (finger), typically the index finger 114, of either hand 112. Referring to FIGS. 1 and 2, the controller 110 takes the form of a circular frame 110′ upon which one or more interaction modules 150 are disposed. The interaction modules 150 include input modules and output modules, suited for receiving or conveying information, respectively, to the user 102. Each input module typically denotes an input switch/switches for receiving input and generating a responsive input signal, typically through electrical connections. The interaction modules 150, such as the exemplary 360 degree lever (colloquially referred to as a finger operated stick, finger stick, control stick or joystick), are accessible from the thumb 116 and middle finger 118 when the circular frame of the controller 110 is inserted around the index finger 114. Alternate structures may be employed for disposing the controller 110 on a finger, such as a “C” shaped clip, or with the addition of protrusions on the frame 110′ for additional controllers. The interaction modules 150, while primarily receiving input from the user, may also take the form of output modules. Such output modules may include a vibration motor, for providing a vibrating sensation to the user, or may be light, text or video displays for rendering LED or LCD based images or signals to the user.

The disclosed finger worn controller 110 therefore defines a user input device having a circular frame 110′ adapted to be worn by the user 102 in conjunction with an application 140 executing on a computing device 130, and a plurality of interaction modules 150 mounted on the circular frame 110. Each interaction module 150 generates an input signal 120 responsive to an activation, such as a finger press, indicative of user input, or receives an output signal 121. An interface 111 to the computing device 130 may be wireless or wired, in which the interface is responsive to the generated input signal for transmitting the input signal 120 to the computing device 130. The interaction modules 150 are disposed around a circumference of the circular frame 110′ and are adapted for access by one of a thumb 116 and middle finger 118 when the circular frame 110′ is worn on an index finger 114 of the user.

Depending on implementation, deployment may include a plurality of circular frames 110′, in which each circular frame 110′ defines a finger-worn device, and the circular frames 110′ have left and right designations for corresponding to a dominant hand of the user 102. The plurality of interaction modules 150-N, therefore, are collectively disposed for activation from digits of a user 102, typically the thumb 116 or middle finger 118 when the controller 110 is worn on the index finger 114. Each of the interaction modules 150 on the circular frame 110′, therefore, is adapted for control from a hand of the user on which the circular frame is worn. The interaction modules 150 are adapted to be activated by at least three fingers on a single hand of the user 102. A plurality of input modules 140 are operable to generate a plurality of input signals 120 directed to a common application 140 on the host computing device 130.

Each interaction module 150 of the plurality of input modules includes at least one sense element adapted to generate the input signal 120 in response to activation from physical contact from a digit of the user 102. In a typical implementation, each interaction module 150 of the plurality of input modules includes at least one switch adapted to generate an electrical signal in response to activation. Similarly, in the case of output modules, the interaction module include a small LED/LCD screen and suitable electronics/power to be responsive to output signals 121 from the computing device 130, such as for messages, visual/graphic feedback, or other signals.

The interaction modules 150 may also be implemented as a “hot plug” fixture that engages a receptacle on the circular frame 110′ for configuring a variety of desired interaction modules on the circular frame. Each interaction module may employ a predetermined plug arrangement for electrical communication with the circular frame, and an interface and/or encoding/protocol information on the interaction module used for establishing communication.

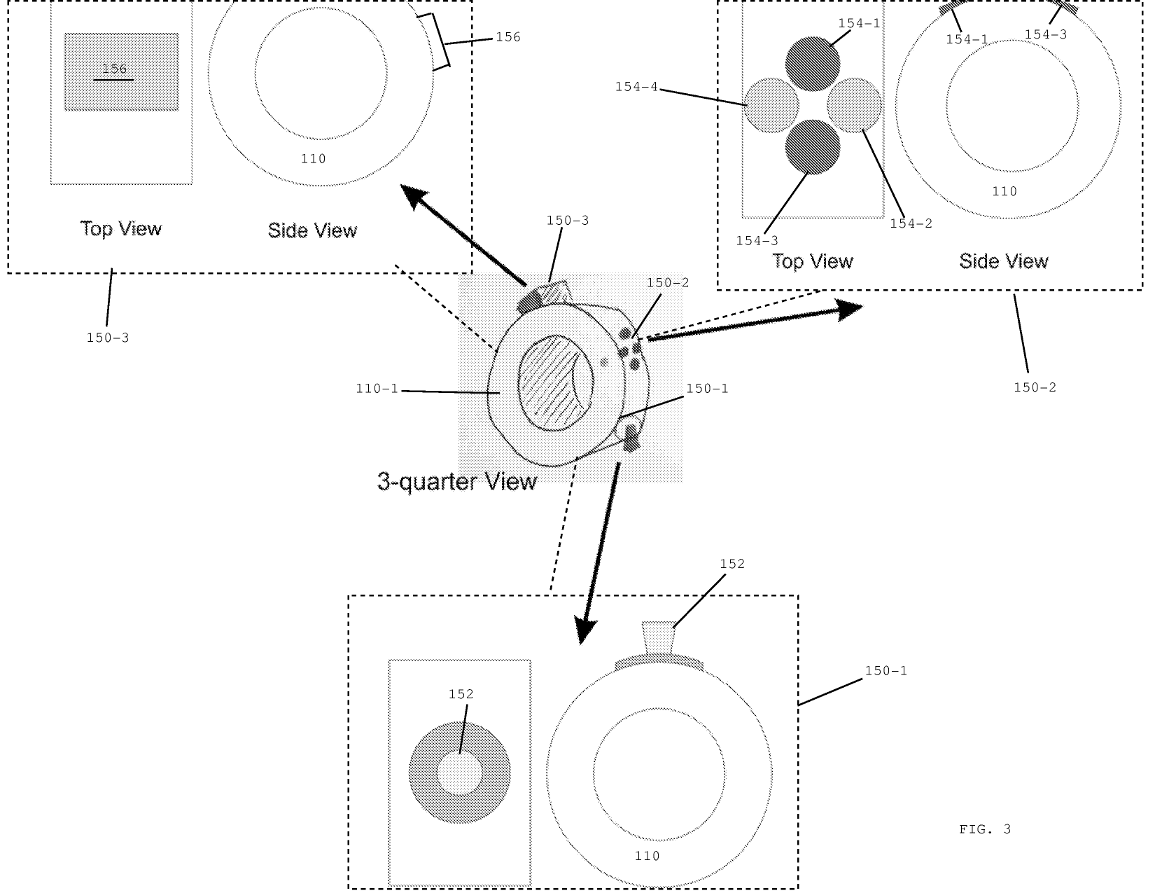

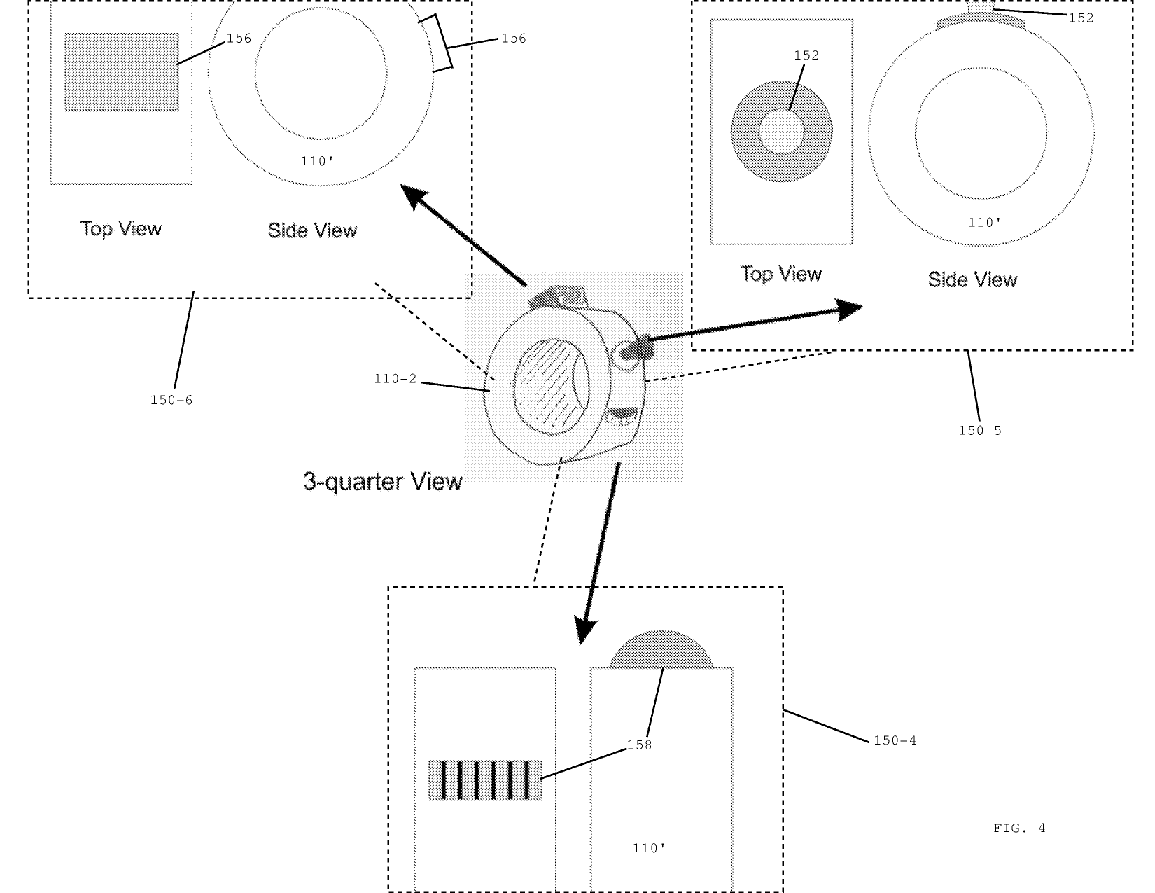

FIG. 3 shows a configuration of a right hand controller 110-1, and FIG. 4 shows a configuration of a left handed controller 110-2. Referring to FIGS. 3 and 4, the example right and left hand deployment may be altered to suit the dominant hand of the user 102, or simply to deploy on a different finger for comfort or to accommodate multiple controllers 110 on the same hand 112. In FIG. 3, the interaction modules 150 on the circular frame include a finger operated stick 150-1, action buttons 150-2, and a trigger button 150-3 (150 generally). The finger operated stick 150-1 includes a finger stick actuator 152, or lever, operable for 360 degree movement. The action buttons 150-2 include four button switches 154-1 . . . 154-4 arranged in a diamond pattern. In contrast to so-called “direction buttons”, having a single contact surface that tilts in different directions, the action buttons return a signal indicating which (one or more) of the four buttons is pressed (actuated). A variety of input signals may therefore be generated by, for example pressing a single or two adjacent buttons. The trigger button 150-3 includes a single actuator switch 156, typically a momentary contact switch that is spring loaded to resiliently return (open) when not depressed. The example arrangements shown depict each of the interaction modules 150 as a form of an electric switch for providing a voltage or set of voltage readings resulting from closing or opening a circuit, or a continuum of readings such as from a potentiometer, as in the case of the finger operated stick 150-1 which may return a range of values depending on the directional force/movement applied in a 2 dimensional x,y plane. Alternate implementations may invoke alternate activation mediums, such as capacitive sense or thermal sense for touch, for example. In general, each of the interaction modules 150 provides a discrete input signal 120 to the application 140 on the console 130, which is interpreted by the application 140. Typical input signals include a direction, firing, jumping, movement, slide bar, selection, and the like. Although the input signal 120 may include a single value or voltage level (trigger button 150-3), or multiple values indicating direction (finger operated stick 150-1, action buttons 150-3), the input signal is intended to be interpreted by the application 140 as an atomic command having a specific meaning to the application.

Therefore, in the example two hand approach depicted, the interaction modules 150 on a first circular frame 110′ include a first trigger push button 150-3 for generating an activation signal when pressed, action buttons 150-2 having a plurality of button switches, such that each button switch is indicative of a direction, and a directional lever (finger operated stick) 150-1 for generating a directional signal indicative of two dimensional movement of the directional lever 152.

As indicated above, the finger operated stick interaction module 150-1 takes the form of a lever having 360 degrees of movement, and is expected to return a range for horizontal and vertical direction. Alternately, a simple 8-position value may be returned to indicate direction in either of the primary four directions (i.e. North, South, East, West), or a component between two directions (NE, SE, SW, NW).

The action button interaction module 150-2 indicate which of the four buttons 154 is pressed. The signal generated from buttons 154 generally is expected to denote a Boolean type or response that can be used by the application 140 to perform different logics, such as attack, block, jump, fire, etc. in a game.

The trigger 150-3 input module provides an activated signal when pressed, and it can denote a continuous signal, as well as a Boolean signal. For an example of continuous signal, when the module 150-5 on FIG. 4 is moving the player character on a game, holding down the trigger 150-3 continuously, makes the character to run. It can also sends Boolean signals, such as reload a weapon or launch a missile, etc. in a game. The corresponding controller (left) 110-2, in the example arrangement, also includes 3 interaction modules 150. A roller 150-4 returns an input signal 120 reflective of rotation range. A push-able scroll wheel or roller 158, similar to an inverted mouse, may also be employed to return a value sequence similar to a mouse wheel delta value. A second finger operated stick 150-5 operates similar to the finger operated stick interaction module 150-1 on the opposed hand 112, and a second trigger 150-6 is generally equivalent to the trigger interaction module 150-3. It should be apparent to those of skill in the art that various combinations and placement of the interaction modules 150 on the circular frame 110′ is achievable within the scope of the disclosed approach.

The interaction modules 150 on a second circular frame include, therefore, a second trigger push button 150-6 for generating an activation signal when pressed, a second directional lever 150-5 for generating a directional signal indicative of two dimensional movement of the directional lever, and a roller 150-4 for generating a wheel rotation signal. When you rotate the wheel, a roller message is sent as each notch is encountered. When the module is integrated horizontally into the device, a positive value indicates that the wheel was rotated right; a negative value indicates that the wheel was rotated left.

The controller 110 invokes the interface 111 to transmit the input signal 120 generated by the interaction modules 150 in any suitable manner. A wireless medium, such as Bluetooth or IEEE 802.11 based communications, avoids tethering the user to the computing device 130, however wired or infrared mechanisms are also suitable.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A user input device comprising:
a circular frame adapted to be worn by a user in conjunction with an application executing on a computing device;
a plurality of interaction modules mounted on the circular frame, each interaction module for generating an input signal responsive to an activation indicative of user input; and
an interface to the computing device, the interface responsive to the generated input signal for transmitting the input signal to the computing device,
the plurality of interaction modules disposed for activation from digits of a user.

2. The device of claim 1 wherein the interaction modules are disposed around a circumference of the circular frame and adapted for access by one of a thumb and middle finger when the circular frame is worn on an index finger of the user.

3. The device of claim 2 further comprising a plurality of circular frames, each defining a finger-worn device, the circular frames having left and right designations for corresponding to a dominant hand of the user.

4. The device of claim 3 wherein each interaction module of the plurality of interaction modules includes at least one sense element adapted to generate the input signal in response to activation from physical contact.

5. The device of claim 2 wherein each interaction module of the plurality of interaction modules includes at least one switch adapted to generate an electrical signal in response to activation.

6. The device of claim 1 wherein each of the interaction modules on the circular frame is adapted for control from a hand of the user on which the circular frame is worn.

7. The device of claim 6 wherein the plurality of interaction modules generate a plurality of input signals directed to a common application on the host computing device.

8. The device of claim 7 wherein the interaction modules on a first circular frame include a first trigger push button for generating an activation signal when pressed, action buttons having a plurality of button switches, each button switch indicative of a unique action signal, and a directional lever for generating a directional signal indicative of two dimensional movement of the directional lever.

9. The device of claim 8 wherein the interaction modules on a second circular frame include a second trigger push button for generating an activation signal when pressed, a second directional lever for generating a directional signal indicative of two dimensional movement of the directional lever, and a roller for generating a continuum signal indicative of an amount of rotation of the roller.

10. The device of claim 9 wherein the interaction modules are input modules disposed around a circumference of the circular frame and adapted for access by one of a thumb and middle finger when the circular frame is worn on an index finger of the user.

11. The device of claim 10 wherein the input modules are adapted for be activated by at least three fingers on a single hand of the user.

12. The device of claim 1 wherein the interaction modules further comprise input modules and output modules, the input modules for generating the input signal and the output modules for rendering an output signal to the user.

13. The device of claim 12 wherein the output modules further comprise at least one of a vibration element, light, LED (Light Emitting Diode) display or a LCD (Liquid Crystal Display).

14. A method for generating computer input comprising:
receiving signals from a circular frame disposed on an index finger of a user, the circular frame having a plurality of interaction modules each adapted for generating an input signal responsive to activation by a user;
transmitting a first signal received at a first interaction module activated by a thumb of the user
transmitting a second signal received at a second interaction module activated by a middle finger of the user,
the transmitted signals configured for receipt by an application on host computing device.

15. The method of claim 14 further comprising disposing the interaction modules as input modules at substantially quadrant intervals around the circumference of the circular frame.

16. The method of claim 14 further comprising disposing the interaction modules as input modules around a circumference of the circular frame for access by one of a thumb and middle finger when the circular frame is worn on an index finger of the user.

17. The method of claim 15 wherein each input module of the plurality of input modules includes at least one sense element for generating the input signal in response to activation from physical contact.

18. The method of claim 15 wherein each input module of the plurality of input modules includes at least one switch for generating an electrical signal in response to activation.

19. The method of claim 18 further comprising generating, by the plurality of input modules, a plurality of input signals directed to a common application on the host computing device.

20. The method of claim 19 wherein the input modules on a first circular frame include a first trigger push button for generating an activation signal when pressed, action buttons having a plurality of button switches, each button switch indicative of a unique action signal, and a directional lever for generating a directional signal indicative of two dimensional movement of the directional lever.

21. The method of claim 19 wherein the input modules on a second circular frame include a second trigger push button for generating an activation signal when pressed, a second directional lever for generating a directional signal indicative of two dimensional movement of the directional lever, and a roller for generating a continuum signal indicative of a degree of rotation of the roller.

22. A computer program product on a non-transitory computer readable storage medium having instructions that, when executed by a processor, perform a method for generating gaming input comprising:
receiving signals from a circular frame disposed on an index finger of a user, the circular frame having a plurality of input modules each adapted for generating an input signal responsive to activation by a user;
transmitting a first signal received at a first input module activated by a thumb of the user
transmitting a second signal received at a second input module activated by a middle finger of the user,
the transmitted signals configured for receipt by an application on host computing device.
